(19) United States
(12) Patent Application Publication
(10) Pub. No.: US 2009/0161377 A1
(43) Pub. Date: Jun. 25, 2009

(54) All-LED light bar for mounting to a vehicle

(76) Inventors: James M. Helms, Fort Meyers, FL (US); Thomas G. Buckner, Gibsonia, PA (US)

Correspondence Address: KAREN TANG-WAI SODINI, 216 horseshoe drive, MARS, PA, 16046, US

(21) Appl. No.: 12/378,527

(22) Filed: Feb. 17, 2009

Related U.S. Application Data
(63) Continuation-in-part of application No. 12/121,932, filed on May 16, 2008, now abandoned.
Application No. 12/121,932 is a continuation of application No. 11/725,580, filed on Mar. 19, 2007, now Pat. No. 7,387,414.
(60) Provisional application No. 60/785,210, filed on Mar. 22, 2006.

(51) Int. Cl. B60Q 1/26

(52) U.S. Cl. 362/493

(57) ABSTRACT

A kit for a light bar for providing auxiliary illumination for a vehicle. Some such light bars typically include several visible-light flood lights and also infrared illuminators. The visible-light flood lights can be provided as high-intensity discharge lights or as LEDs. The infrared illuminators are provided as LEDs. A switch box is provided for use in the cabin of the vehicle for turning on and off the lights. A light bar, typically a front light bar, can be provided with strobe lights in place of some of the flood lights. A shield may be provided as part of a front light bar to protect the lights when not in use, and to keep the lights from striking the front of the vehicle.

### CROSS REFERENCE To RELATED APPLICATION

This application is a continuation-in-part of U.S. patent application Ser. No. 12/121,932 filed May 16, 2008, now abandoned, from which priority is claimed under all applicable sections of Title 35 of the United States Code including, but not limited to, Sections 120, 121, and 365(c), and which in turn is a continuation of U.S. patent application Ser. No. 11/725,580 filed Mar. 19, 2007, which in turn makes reference to and claims priority from U.S. provisional application Ser. No. 60/785,210 filed Mar. 22, 2006.

### BACKGROUND OF THE INVENTION

1. Technical Field

The present invention pertains to the field of lighting equipment, and in particular for lighting equipment mounted to a vehicle for providing enhanced illumination in the visible spectrum and also illumination in the near infra-red spectrum.

2. Problem Solved by the Invention

Lights provided as standard with some military vehicles, and in particular the HMMWV (High Mobility Multipurpose Wheeled Vehicle), are of relatively low intensity and typically provide illumination in only the visible spectrum. In addition, they are intended to be used in a non-flashing mode when the vehicle is in operation.

In many circumstances, it is advantageous for a vehicle, and especially a military vehicle such as the HMMWV, and especially in combat operations, to provide illumination of greater intensity than comes standard. It is also advantageous to provide illumination in the infrared. Finally, for some applications, flashing lights of various colors are useful.

What is therefore needed is a way to upfit such vehicles with such non-standard lighting.

### DISCLOSURE OF INVENTION

The invention provides a light bar, including both visible light sources and also infrared (IR) light sources, that can attach to the front of a vehicle, on top of the cabin, and/or on the sides or back of the vehicle, on top of the cabin or at other advantageous attachment points. The light bar includes at least one or more visible light sources and one or more IR light sources, all of which are provided as light emitting diodes (LEDs). The light bar includes a housing, made of typically aluminum or another metal, that houses the LEDs and to which the LEDs are attached so as to facilitate heat transfer from the LEDs to the housing, which is provided as an extrusion of high surface area, thus providing for a high rate of cooling of the LEDs by conduction to the housing, and by radiation from the housing. To facilitate heat transfer from the LEDs to the housing, the LEDs are mounted on an aluminum (or other metal) printed circuit board, and the printed circuit board is mechanically attached to the housing. In a particularly advantageous embodiment, a conductive film or grease is applied to the housing side of the printed circuit board before the board is attached (via fasteners of one sort or another) to the housing.

The light bar can be attached to essentially any vehicle, at any number of locations, by mounting hardware specially designed for the vehicle and the location on the vehicle where the light bar is to be attached.

In addition, in some embodiments, the invention includes equipment for mounting the light bars to a vehicle, equipment for providing electric power to the light bars, and equipment for turning on and off the light bars.

### BRIEF DESCRIPTION OF THE DRAWINGS

The above and other objects, features and advantages of the invention will become apparent from a consideration of the subsequent detailed description presented in connection with accompanying drawings, in which:

FIG. 1A is a perspective drawing of a front light bar according to an embodiment of the invention, including visible-light flood lights and IR illuminators (serving as IR floodlights), mounted on the front of a HMMWV.

FIG. 1B is a plan drawing of a front mounting bracket, for mounting a front light bar to the front of a HMMWV.

FIG. 1C is a perspective drawing of a front light bar kernel, holding six visible-light flood lights and two IR illuminators.

FIG. 1D is a perspective drawing of a front light bar kernel in the deployed configuration and also in the stowed position, where it is protected by a shield.

FIG. 2A is a perspective drawing of a rear light bar according to the invention, mounted on the rear of a HMMWV.

FIG. 2B is a plan drawing of a rear mounting bracket, for mounting a rear light bar to the rear of a HMMWV.

FIG. 2C is a perspective drawing of a rear light bar kernel, holding four visible-light flood lights and two IR illuminators.

FIG. 3A is a perspective drawing of a switch box, for turning on and off the lights on the front and rear light bar.

FIG. 3B is a perspective drawing of a cable for connecting the switch box to a power source and to the front and rear light bars.

FIG. 4 is a perspective drawing of a cable for connecting the power source to the front and rear light bars and to the switch box (via cables from each).

FIG. 5A is a block diagram/flow diagram illustrating cabling from a functional perspective.

FIG. 5B is a block diagram illustrating the physical interconnections of the cabling.

FIG. 6 is a block diagram/schematic of a light bar including various different visible-light strobe lights as well as visible-light flood lights and IR illuminators.

FIG. 7 is a perspective drawing of an all-LED lightbar, according to the invention, having a housing containing visible-light LEDS and IR LEDs.

FIG. 8 is an exploded view of the all-LED lightbar of FIG. 7.

FIG. 9 is a perspective drawing of one module of lights of the all-LED lightbar, i.e. one printed circuit board on which are mounted six LEDs, which may be all visible-light LEDs or all IR LEDs, and a (controller) buck puck, and which are therefore one food light in case of visible-light LEDs, or one infrared illuminator, in case of IR LEDs.

FIG. 10 is a perspective drawing of a portion of an extrusion used for the housing for the lightbar of FIG. 7, in some embodiments.

FIG. 11 is a cross section of the extrusion of FIG. 10, taken at ninety degrees to the length of the housing.

FIG. 12 is a block diagram showing the interconnection of two light bars, a switch box, and a vehicle battery.

### DRAWINGS LIST OF REFERENCE NUMERALS

The following is a list of reference labels used in the drawings to label components of different embodiments of the invention, and the names of the indicated components.

10 light bar

10a light bar housing

10b mounting brackets

10c cabling

10d HID light, flood light

10e IR illuminator module

10f shield

10g connector

10h connector

12 rear light bar

12a rear light bar housing

12b rear mount bracket

12c rear light bar cabling

12d flood light

12e IR illuminator module

12f slotted hole

31 switch box

32 switch box cabling

32a connector

32b connector

32c connector

41 battery cable

41a terminal

41b connector

51 coupling

52 coupling

53 coupling

70 lightbar

71 housing

71a groove

71b screw holes

72 cooling fins

73a LED

73b printed circuit boards

73c buck puck or controller module

74 end cover

75 transparent cover

### DETAILED DESCRIPTION

A light bar according to the invention is lightweight, inconspicuous, and rugged, and connects directly to the electrical system or battery of the vehicle, i.e. to some electrical power source of the vehicle. The light bar itself is installed in machined aluminum housing. In some embodiments, the flood lights and/or the infrared (IR) illuminator modules can be placed in receptacles at different locations in the light bar, to adjust the illumination pattern for wide angle illumination of use for viewing the nearby surrounding area, or for narrow angle viewing of objects at greater distance from the vehicle. In a typical application, the flood lights can be configured so that at 200 m, an 88 m span is illuminated.

The invention is described next in an embodiment for use on a HMMWV, an embodiment that includes both a front light bar and a rear light bar. The invention though, mounts on and is especially designed for any military vehicle, and can also be used in civilian applications. For example, a light bar according to the invention can be used on police or security vehicles, or on the private vehicles of volunteer firemen.

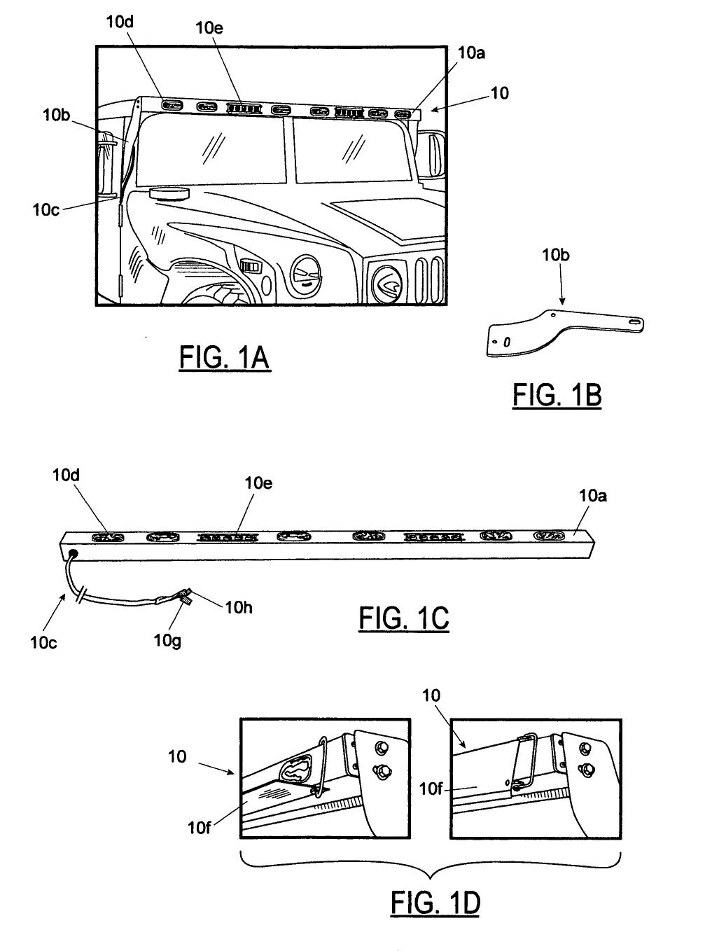

Referring now to FIGS. 1A-D, a light bar 10 according to an embodiment of the invention in which the visible light is provided by high intensity discharge (HID) lights, instead of LEDs, includes a front light bar housing 10a mounted on the front of a HMMWV using two front light bar mounting brackets 10b, one on either end of the light bar. The light bar, in the embodiment shown, includes six HID lights 10d and two IR illuminator modules 10e, each module including a plurality of IR LEDs. The light bar housing 10a with the lights (flood lights and IR illuminators) mounted therein is here called a light bar kernel.

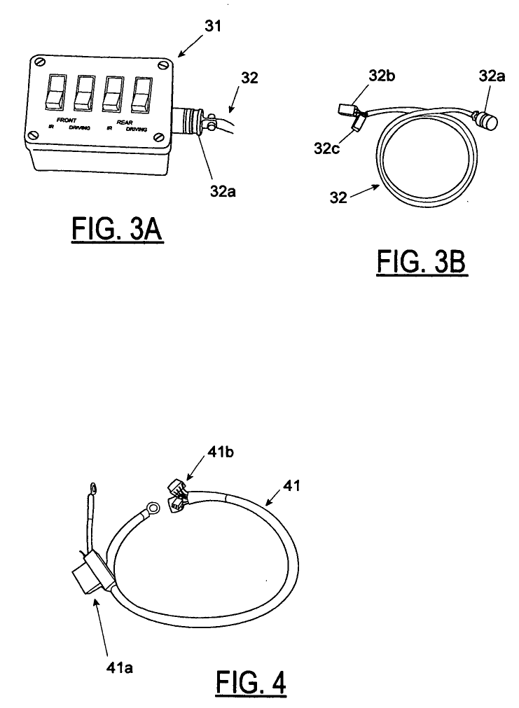

Referring now also to FIGS. 3 and 4, electrical power and control is provided to the front light bar by cabling 10c, having a cable with a connector 10g for connecting to a battery or to the electrical system of the vehicle via a battery cable 41, and a connector 10h for connecting to a switch box 31 via switch box cabling 32. The switch box 31 is positioned inside the vehicle so as to be accessible to a vehicle operator. Using the switchbox 31, the vehicle operator can open and close relays (not shown) in the front or rear light bar to turn on or off power to either the IR illuminators or the flood lights. The switchbox is thus connected to the front and rear light bars for providing a control signal, and is connected to the battery or electrical system to obtain the electric power needed to open and close the relays in the light bars. For these connections, the switch box cabling 32 has a connector 32a at one end for connecting to the switch box, and has at the other end a connector 32b for connecting to the battery cabling 41 and a connector 32c for connecting to both light bars (via an adapter, not shown). The battery cabling 41 has at one end two terminals 41a, one for connecting to the positive terminal and one for connecting to the negative terminal of the vehicle battery (or for connecting to another part of the electrical system of the vehicle) and at the other end two connectors 41b, one for connecting to the switch box, and another for connecting to the light bars (via the adapter, not shown). The operating voltage is typically 24VDC.

The high intensity white flood lights 10d can be conventional flood lights, relying on a filament, or can be HID lights, i.e. relying on gas discharge, instead of a filament, or can be LEDs, as explained below. Further, and advantageously, the flood lights 10d can be shock mounted in the light bar housing 10a. For example, the flood lights can be held to the light bar housing using (e.g. four) screws, with respective rubber grommets pierced by the screws and isolating the flood lights mechanically from the light bar, and hence from the vehicle itself. Such an arrangement is of use in case of using a light bar according to the invention on a vehicle such as a tank, having less of a shock-absorbing suspension system. In case of LEDs, the LEDs are mounted on a printed circuit board, which is then attached to the housing, and so the printed circuit board would be shock mounted.

Each IR illuminator module 10e typically includes five IR LEDs (light emitting diodes), as shown in FIGS. 1A and 1C. In a typical embodiment, the IR LEDs provide illumination centered at 880 nanometers (nm) or at 940 nm, both of which provide a good match for night vision equipment, such as night vision goggles (NVGs), typically used by vehicle operators. The IR illuminators enable driving at normal operating speed when using night vision devices, and enable seeing well beyond what is possible with only NVGs.

Specifications for an IR illuminator of a type typically used in the invention are provided in Table 1. An IR illuminator appropriate for use with the invention is e.g. the “Super High-Power GaAlAs IR Emitter” OD-50L, available from Opto Diode Corporation, of Newbury Park, Calif.

TABLE 1
Specifications for typical IR illuminator modules
for use in the front and/or rear light bars.

| Emitting Material | GaAlAs (Gallium Aluminum Arsenide) | |
|---|---|---|
| Half Intensity Beam Angle | 7 | deg. |
| Peak Emitting Wavelength | 880 | nm |
| Forward Current per diode | 500 | mA |
| Peak Forward Current | 10 | A |
| Power Distribution | 1000 | mW |
| Radiant Intensity | 500 | mW/sr |
| Typical total power output | 50 | mW for forward current of 500 mA |
| | 600 | mw for forward current of 10 A |

Referring now in particular to FIG. 1D, in a particularly advantageous embodiment, the light bar is provided so as to have a fold-down shield 10f that protects the lights when not in use, and that eliminates glare caused by light reflecting off the hood of the vehicle when the flood lights are turned on.

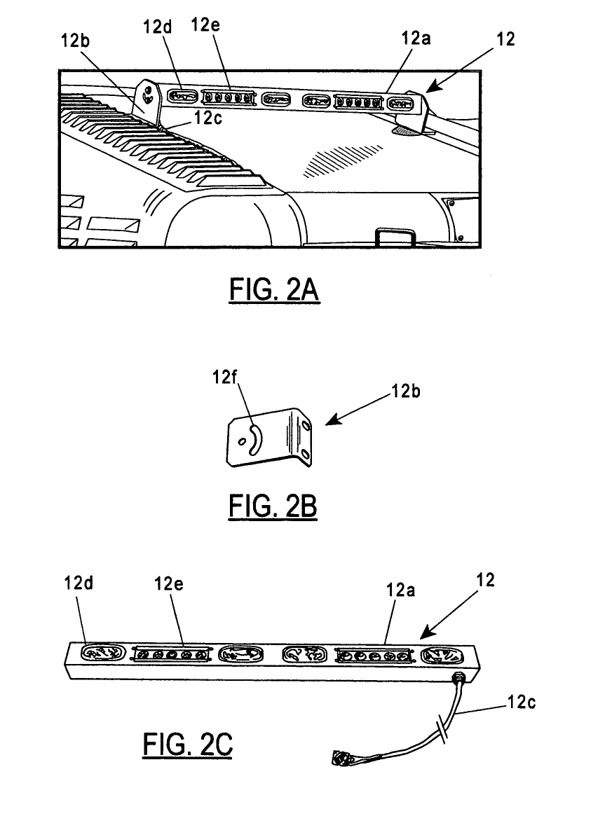

Referring now to FIGS. 2A-C, the invention can also provide a rear light bar 12, i.e. a light bar for mounting on the rear of the vehicle for providing illumination in the rearward direction. In the embodiment shown in FIGS. 2A-C, the rear light bar includes a rear light bar housing 12a, for holding four flood lights 12d and two IR illuminator modules 12e. Power and control is provided by rear light bar cabling 12c, connected as described above for the front light bar. The rear light bar housing is mounted to the rear of the HMMWV using two rear mount brackets 12b each having a slotted hole 12f, to enable adjusting the look down angle of the housing and the flood lights and IR illuminators held in the housing.

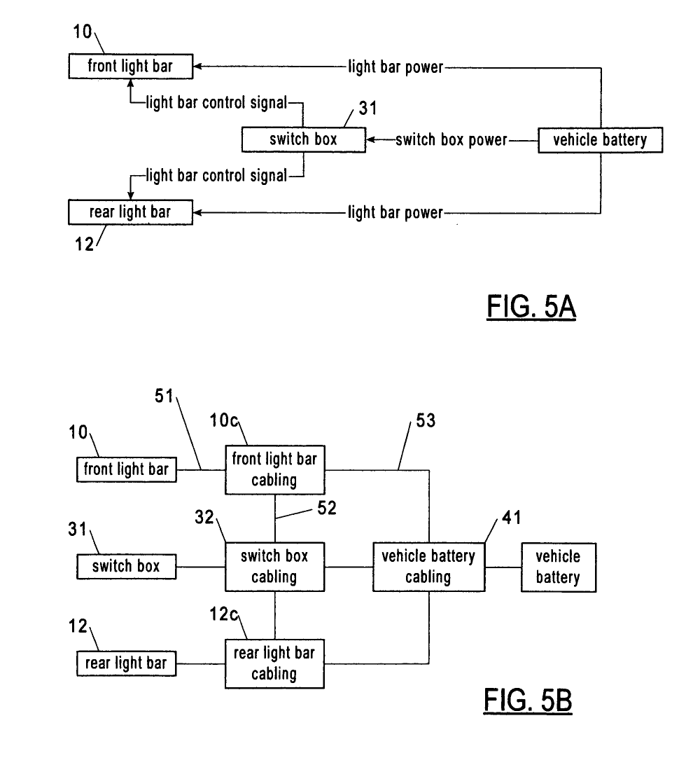

Referring now to FIG. 5A, the connections of the cabling 10c 12c 32 and 41 described above provide, as also described above and illustrated in FIG. 5A, an electrical connection from the switch box 31 to the vehicle battery (or electrical system) for power to the switch box, electrical connections from the switch box to the front and rear light bars 10 and 12 for providing control signals thereto, and electrical connections of the battery (or vehicle electrical system) to the front and rear light bars for providing power to the light bars. As shown in FIG. 5B, these various connections are provided by the front and rear light bar cabling 10c and 12c, the switch box cabling 32, and the battery cabling 41. Thus, for example and as shown in FIG. 5B, the coupling 51 between the front light bar cabling and the front light bar provides both power and control signaling, the coupling 52 between the front light bar cabling and the switch box cabling provides only control signaling, and the coupling 53 between the front light bar cabling and the battery cabling provides only power.

Referring again to FIGS. 1A-C, 2A-C, 3A-B, and 4, the front and rear light bars 10 and 12 can be mounted to the HMMWV as follows:

To mount the front light bar: First, attach each of the two front mounts 10b (FIG. 1B) to the front light bar housing 10a with two ⅜″×1″ bolts, two ⅜″ lock washers, and two ⅜″ washers, in that order. Leave all bolts slightly loose. Next, remove the existing left and right mirror assemblies from the HMMWV. Retain all hardware. Then replace the left and right mirror assembles on the HMMWV, with the light bar mounts between the mirror mounting brackets and the HMMWV body. Leave all bolts slightly loose. Next, adjust the light bar position as necessary so that the light bar does not touch the windshield wipers, so that it is level with the HMMWV, and so that the front face is vertical, i.e. so that the lights point straight out away from the vehicle, and aimed horizontally (not pitched up or down). Tighten all fasteners to secure the front light bar housing to the vehicle. Finally, place the front light bar cabling 10c through the door jamb (as shown in FIG. 1), and then route under the dashboard of the vehicle.

To mount the rear light bar: First, attach each of the two rear mounts 12b to the rear light bar housing 12a with two ⅜″×1″ bolts, two ⅜″ lock washers, and two ⅜″ washers, in that order. Attach the top bolts first. Leave all bolts slightly loose. Next, determine where the rear light bar should be located on the rear body or deck of the HMMWV. It is best if the rear light bar does not interfere with any roof-mounted items. Place the rear light bar at the selected location, and mark on the vehicle the location of the bolt holes in the rear light bar housing. Next, drill 5/16″ holes through the HMMWV body and deburr. Then attach the rear light bar housing to the HMMWV with four 5/16″ bolts, four 5/16″ washers, four 5/16″ washers, four 5/16″ lock washers, and four 5/16″ nuts, in that order. Leave all hardware slightly loose. Next, adjust the light bar position as necessary so that the light bar is level with the HMMWV, and the rear face is vertical, i.e. so that the lights point straight out away from the vehicle, and aimed horizontally. Tighten all fasteners to secure the rear light bar housing to the vehicle. Finally, route the rear light bar cabling to the inside of the HMMWV.

Next, connect the battery cabling 41 to the battery. One cable of the battery cabling is red, which is to be connected to the positive terminal of the battery.

Next, install the switch box in the cab of the HMMWV, using four ¼″ screws, four ¼″ lock washers, and four ¼″ washers.

Finally, connect all cabling. First, connect the front and rear light bar power cables of the respective cabling 10c and 12c to the battery cabling 41, as described above, and also connect the switch box cabling to the battery cabling as described above. Then connect the switch box cabling to the front and rear light bar cabling 10c and 12c, as described above.

It can be appreciated by those skilled in the art that there are many ways to turn on and off the IR illuminators and/or the flood lights of a front or rear light bar according to the invention, and that in different arrangements, the cabling for power to a light bar and to the switch box can be different. In particular, power for the switch box can be provided by tapping the power line to one or another of the light bars. In addition, power to both light bars can be provided through the switch box, in which case the switch box can include simple switches, instead of providing a control signal to close or open a relay in the light bars (and thus to turn on or off power to the light bars).

In a typical embodiment, the switch box has four switches, one for each of the two sets of flood lights (one set in the front light bar, and one in the rear), and one for each of the two sets of IR illuminators. In some embodiments, one switch controls all flood lights and one switch controls all IR illuminators.

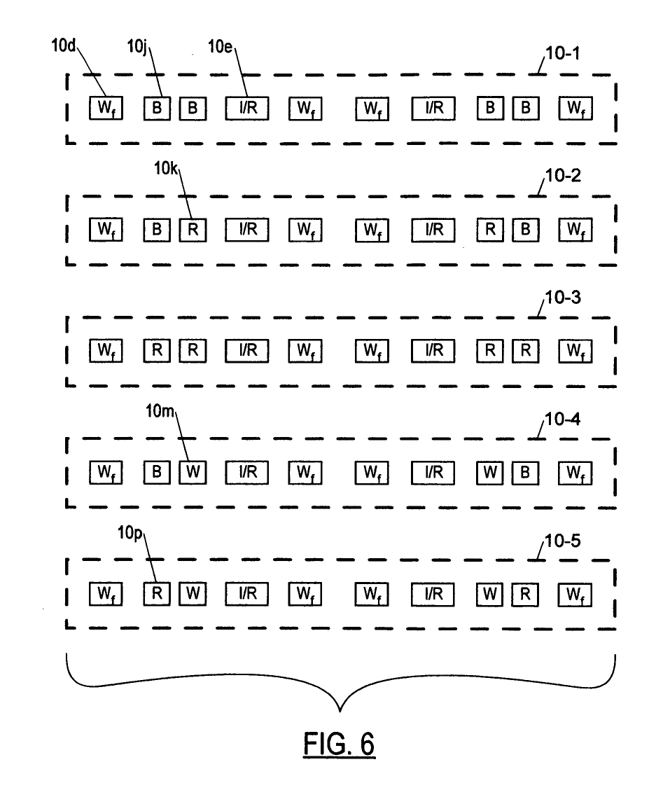

Referring now to FIG. 6, various front light bars are shown including strobe lights, in replacement of some of the flood lights. Thus, a front light bar 10-1 is shown as including two IR illuminators 10e as in FIG. 1, but only four white flood lights (W_{f}) 10d, and in replacement of the other two flood lights 10d of FIG. 1, two sets of two blue strobe lights 10j (i.e. four blue strobe lights 10j in all) are provided. Also shown is a front light bar 10-2 having two red strobe lights 10k and two blue strobe lights. Also shown is a front light bar 10-3 having four red strobe lights. Also shown is a front light bar 10-4 having two blue strobe lights and two white strobe lights 10m. Also shown is a front light bar 10-5 having two red strobe lights and two white strobe lights. All of these various arrangements and configurations are of course of use in particular military and civilian applications.

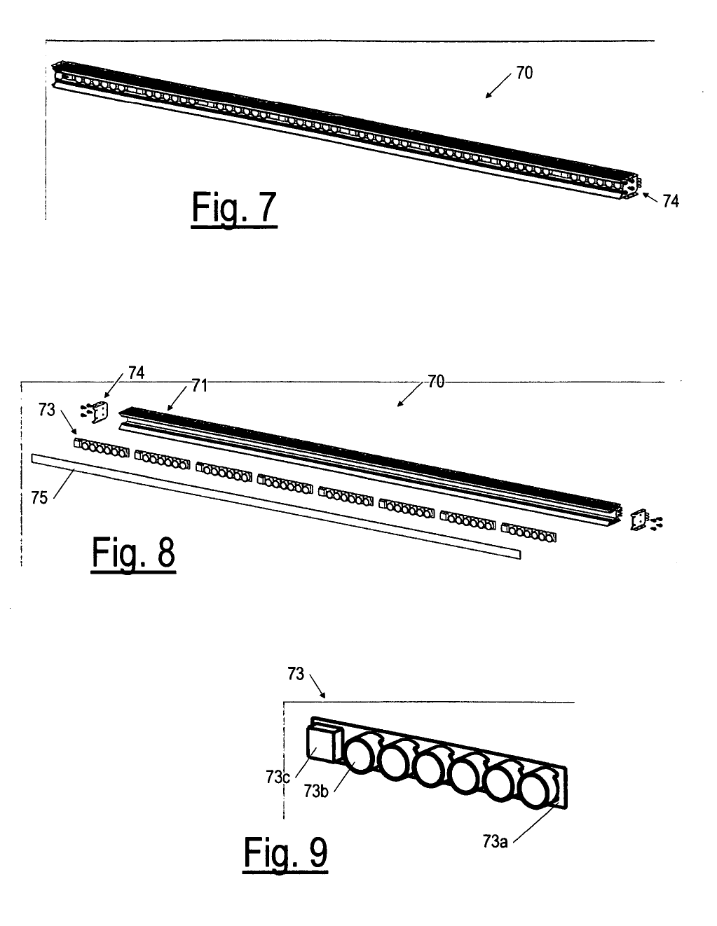

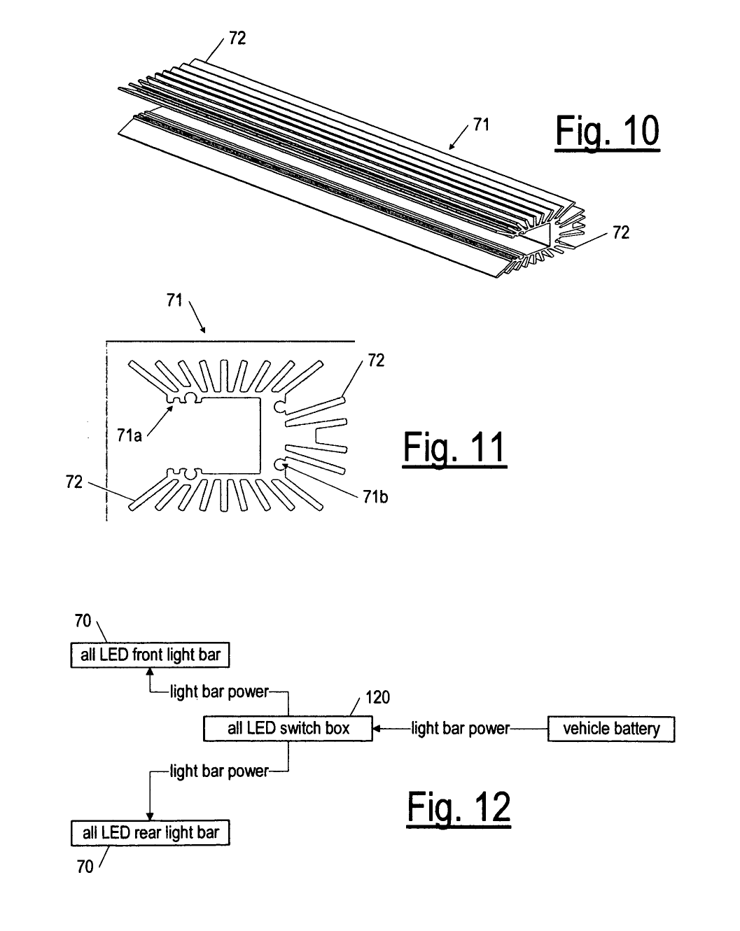

Referring now to FIGS. 7-11, in another embodiment of the invention, one in which only LEDs are used (i.e. for both visible light and IR light), the invention provides a lightbar 70 including a housing 71, made e.g. as an aluminum extrusion, although other methods of fabrication are of course possible, especially including a casting, such as a die casting. As shown in particular in FIG. 11, the housing has cooling fins 72 over at least a portion of the length of the housing. The cooling fins provide a high surface area, and in fact the inventors have found that it is possible, using cooling fins such as shown in FIGS. 7-11, to adequately cool the lightbar (caused by operation of the high-power LEDs, either visible or infrared) without using a fan, i.e. without relying on forced convection. The cooling fins are, for many applications, advantageously made to withstand a significant amount of mishandling and wear and tear, and so are made to have significant strength. Thus, for such applications, to achieve the high surface area needed for adequate cooling, the cooling fins are made fewer in number, but longer and thicker than what might be provided in applications where durability is not a consideration. Such are the cooling fins 72 illustrated in FIG. 11.

In a typical embodiment, eight lights/modules (each either an IR light or a visible light) each comprising six high-power LEDs as described below (either all visible-light LEDs or all IR LEDs), would be housed in a housing of 66″ length, with cooling fins as shown in FIG. 11. The cooling fins typically range in length from about ½″ to about ¾″, and can accommodate six lights (36 LEDs) on at the same time.

In the embodiment illustrated in FIGS. 7-11, the extremities of the cooling fins define a rectangular surface, rather than a curved surface, in order to better interface the light bar with other equipment, or with the surface of the vehicle on which the light bar is mounted. However, it should be understood that the invention encompasses cooling fins of other shapes and orientations.

LEDs 73a are mounted in groups of typically six (all IR LEDs or all visible-light LEDs) to aluminum printed circuit boards 73b, which are fastened to the housing via fasteners (typically screws, not shown), so as to establish mechanical and therefore thermal contact with the housing. Advantageously, before fastening the printed circuit boards to the housing, thermally conductive paste (or grease) is applied to the side of the printed circuit boards that mate with the inside of the housing when the boards are fastened to the housing. Each printed circuit board includes, in a typical and advantageous embodiment, six LEDs (all IR or all visible, to enable turning on or off only visible light or only IR light), and a so-called buck puck 73c, i.e. a controller module for providing proper current to the LEDs. Each such group of six LEDs is called here a visible-light flood light, if the light is visible, or an infrared illuminator, if the light is infrared light. The lights are typically covered by a transparent (to visible light and IR) plastic cover 75, inserted into grooves 71a (FIG. 11) in the extrusion (or casting). End covers 74 are provided to close both ends of the light bar, and are attached e.g. by screws threaded into screw holes 71b (FIG. 11) in the extrusion (or casting).

IR LEDs of a sort suitable for use in such embodiments as are illustrated in FIGS. 7-11 are the same as are suitable for use in embodiments using HID lights. In addition to the above described IR LEDs, suitable IR LEDs are available from OSRAM, headquartered in Munich, DE (Germany), as part 94NMSFH4231. Visible-light LEDs of a sort suitable for use in the all-LED embodiments illustrated in FIGS. 7-11 are e.g. OSRAM part LUW W5AP. Both of these kinds of LEDs are placed beneath lenses providing a beam pattern appropriate to a flood light application or a combination flood light and spotlight. For the visible light LEDs, a suitable floodlight type lens is available as part number LD1-SS from Ledil, of Salo, Finland. For IR, a suitable floodlight type lens is part number OSS-O, also available from Ledil.

The buck puck used for the IR LEDs is the same as for the visible-light LEDs. An appropriate buck puck is available from Luxeon Star LEDs, as puck part number 3021-D-I-1000 (Buck puck driver rated at 1 amp).

Referring now especially to FIG. 12, in such all-LED embodiments, the LEDs are typically turned on and off from a switch box such as the switch box 31 described above, but in some embodiments, as shown in FIG. 12, the switch box includes switches that open and close to control power to the lights of the lightbar, whereas in the embodiments described above, using HID lights for the visible light, the switch box operated relays in the lightbar, to turn on and off power to the lights.

It is to be understood that the above-described arrangements are only illustrative of the application of the principles of the present invention. Numerous modifications and alternative arrangements may be devised by those skilled in the art without departing from the scope of the present invention.

What is claimed is:

1. A kit, for providing an apparatus for providing auxiliary illumination for a vehicle having a source of electric power, comprising:
a light bar, including a metallic or thermally conductive housing holding at least one visible-light flood light and at least one IR illuminator; and
wherein the visible-light flood light comprises a plurality of visible-light LEDs, and the IR illuminator comprises a plurality of IR-light LEDs;
wherein all the visible-light LEDS and all the IR-light LEDs are mounted on one or more metallic of thermally conductive printed circuit boards;
wherein the printed circuit boards are mechanically attached to the housing so as to allow heat flow from the printed circuit boards to the housing; and
wherein the housing is at least in part an extrusion having cooling fins imparting to the housing a high surface area sufficient to remove heat from the light bar without relying on forced convection.

2. A kit, as in claim 1, further comprising a switch box, including switches for providing control signals for switching on or off the at least one visible-light flood light and the at least one IR illuminator.

3. A kit as in claim 1, further comprising at least one strobe light, and wherein the switch box further includes a switch for switching on or off power to the strobe light.

4. A kit as in claim 1, wherein the light bar includes a shield rotatably attached to the housing so as to allow covering the flood light and the infrared illuminator in one position, and so as to allow blocking light from the flood light and the infrared illuminator from reaching the body of the vehicle, in another position.
